(19) United States
(12) Patent Application Publication
(10) Pub. No.: US 2016/0078128 A1
(43) Pub. Date: Mar. 17, 2016

(54) SYSTEMS AND METHODS FOR SEMANTICALLY-INFORMED QUERYING OF TIME SERIES DATA STORES

(71) Applicant: General Electric Company, Schenectady, NY (US)

(72) Inventors: Justin McHugh, Niskayuna, NY (US); Paul Edward Cuddihy, Niskayuna, NY (US); Christina Ann Leber, Niskayuna, NY (US); Ravi Kiran Reddy Palla, Niskayuna, NY (US)

(21) Appl. No.: 14/485,155

(22) Filed: Sep. 12, 2014

(51) Int. Cl. G06F 17/30; G06F 17/27

(52) U.S. Cl. CPC G06F 17/30696; G06F 17/2705

(57) ABSTRACT

Systems and methods for querying time series data using a semantically-informed search. The method including receiving from a client computer a data request for time series data records stored in a time series database, parsing the data request by accessing one or more ontologies in a semantic data store to determine a set of values pertinent to the received request, applying the determined set of values to a model representing a relationship applicable to the time series data, assembling a query compatible to a format implemented in the time series database, and querying the time series database with the assembled query. The received data request describes requested data in terms of one or more available models, the available models representing relationships applicable to the time series data, and the parsing step includes implementing sematic technology to access the ontologies. A system for implementing the method and a non-transitory computer-readable medium are also disclosed.

### BACKGROUND

The growth of low-cost and reliable sensor technology has led to the spread of data collection across all sorts of monitored devices—e.g., machinery, cellular phones, engines, vehicles, turbines, appliances, medical telemetry, industrial process plant, etc. This sensor data is time series data because it takes the format of a value or set of values with a corresponding time stamp, or temporal ordering. The data itself can be analyzed to extract meaningful statistics and other characteristics. Forecasting future performance can be achieved by applying previously observed data values to a model.

Processing time series data has proven challenging because the storage mechanisms used for such data are optimized for rapid storage and retrieval, not for the convenience of users who are not skilled in the use of such storage systems—for example database management systems (DBMS) can be hierarchical, network, relational, or object-oriented. This leads to a problem where the users wishing to use the collected sensor data are often forced to either become skilled in the particulars of the storage format or go through a skilled intermediary to obtain desired data.

Existing systems for storing time series data do so in a means convenient to the goal of the rapid storage and retrieval of the data. However, these conventional systems do not place an emphasis on making the storage configuration understandable to a user not skilled in the particulars of the storage platform. This forms a disconnection between the needs of users skilled in the use of the stored data and their access to the time series data.

Prior solutions embed representative models directly into applications interacting with the data. This is problematic as it involves both a repetition of labor to include the model in every applicable application, as well as a potentially large effort to update and redeploy the applications should the models need alterations. Other attempts involve using relational databases to store information needed to contextualize the time series data. Although this can be useful, relational database systems are not designed to handle this type of data well.

Many useful models for describing systems which generate time series data can be represented well in hierarchal terms, whether as collections of interacting parts or flow diagrams for analytics. The relational database, though capable of describing such systems incurs significant management overhead in the construction, maintenance and query of such descriptions. Conventional implementations repeatedly construct and embed in-application models, which creates difficult to manage silos.

### BRIEF DESCRIPTION OF THE DRAWINGS

FIG. 1 depicts a system in accordance with some embodiments;

FIG. 2 depicts server components in accordance with the system depicted in FIG. 1;

FIG. 3 depicts a process in accordance with some embodiments; and.

FIG. 4 depicts a system in accordance with some embodiments.

### DETAILED DESCRIPTION

In accordance with embodiments, time-series data is queried via storage-layout independent representations of systems used to generate said system which can use models tailored to the field of interest of subject matter experts so that these users (who are typically not skilled in the storage system's technology and/or operation) can interact with the data effectively. These same representations can be queried by automated tools as well, forming an abstraction layer between the literal storage mechanism (e.g., database, data store, etc.) and the access to the data, expressed in terms familiar to those in the domain to which the data refers. Once such an abstracted retrieval is in place, the particulars of the storage can be treated as a matter solely of technical convenience, allowing the underlying storage to be altered, updated or replaced entirely. An automatic, mediated link exists between the higher-level representation and the time series data storage mechanism.

Embodying systems and methods provide for querying time series data, such as collected sensor data, using a semantically-informed search in order to make the data more accessible to users who are not data system experts. These systems and methods apply semantic web technology to allow a user with any level of familiarity with the system producing the time series data to search for time series data using terminology relevant to their interests without requiring knowledge of the underlying time series data storage.

In accordance with embodiments, a querying layer applies semantic web technologies for the retrieval of data from a time series data store. A set of one or more computable models representing relationships applicable to the data in the time series store and exposing these models through a semantic querying front end such as SPARQL. These exposed models are used to translate requests from a predefined, supported high level of detail (e.g., the name of an assembly and/or grouping of components) to the lower level collection of values (e.g., sensor readings, data, and/or calculated values) as stored in the data store. The exposed models are used to determine the mechanism to present the request(s) to the time series data store. Once the collection of values to be queried is obtained, the system can automatically generate a query against the linked time series data store to retrieve the relevant data.

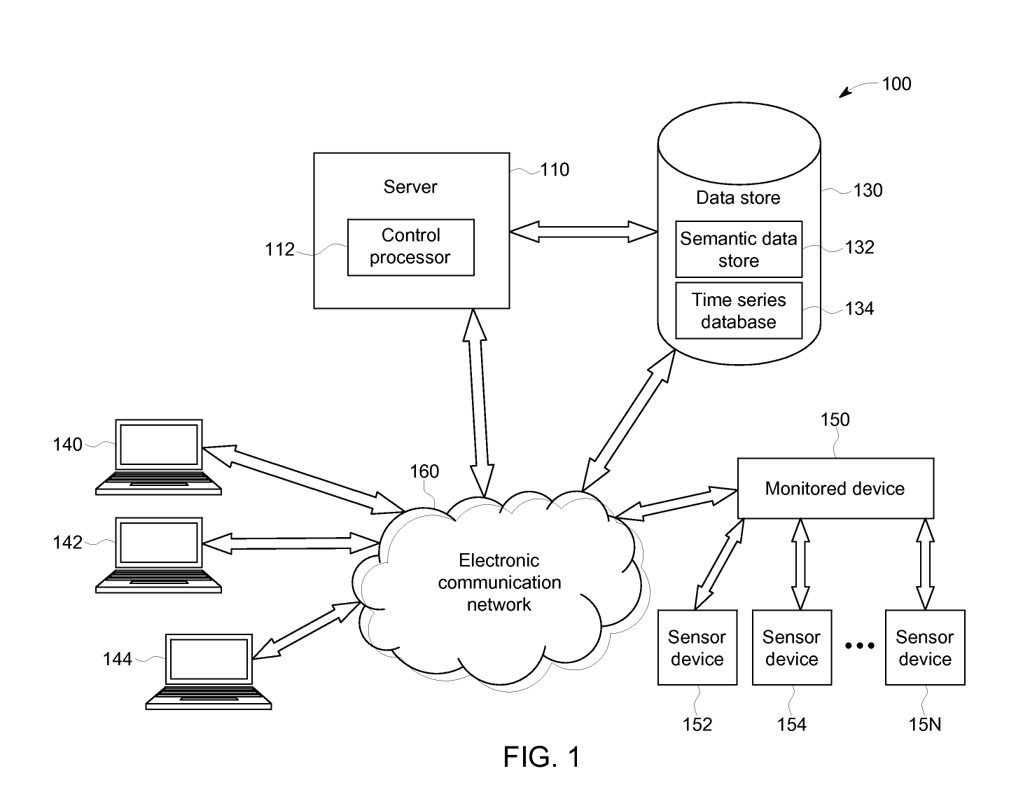

FIG. 1 depicts system 100 for implementing semantically-informed querying of time series data in accordance with embodiments. System 100 can include server 110 that can include at least one control processor. The control processor may be a processing unit, a field programmable gate array, discrete analog circuitry, digital circuitry, an application specific integrated circuit, a digital signal processor, a reduced instruction set computer processor, etc. Server 110 may include internal memory (e.g., volatile and/or non-volatile memory devices) coupled to the control processor.

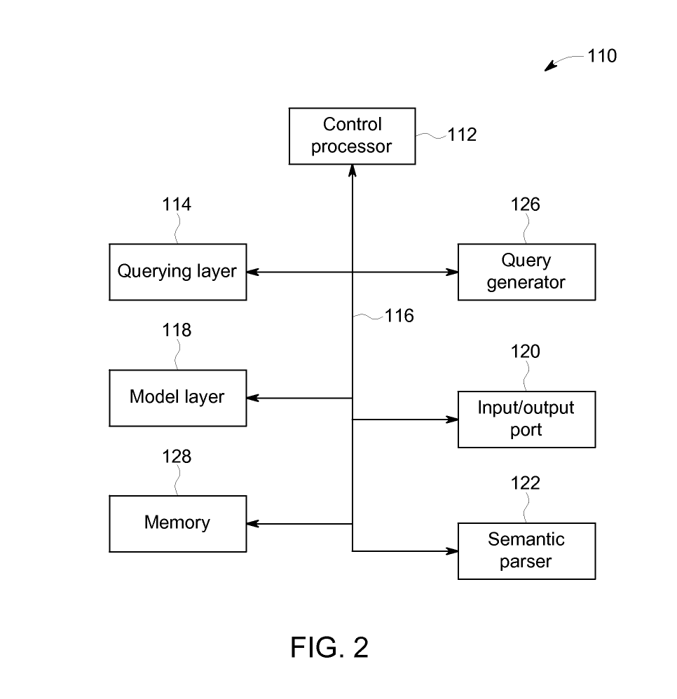

FIG. 2 depicts components of server 110 in accordance with some embodiments. Server 110 can include communication bus 116 that couples control processor 112 to the various components of the server. The server can include querying layer 114, model layer 118, semantic parser 122, and query generator 126. Each of these server components can be implemented as dedicated hardware, software, and/or firmware modules.

The control processor may access a computer application program stored in non-volatile internal memory 128, or stored in an external memory that can be connected to the control processor via input/output (I/O) port 120. The computer program application may include code or executable instructions that when executed may instruct, or cause, the control processor and other components of the server to perform embodying methods, such as a method of querying time series data using a semantically-informed search to make the data more accessible to users who are not data system experts.

With reference to FIG. 1, server 110 can be in communication with data store 130. Data store 130 can be part of a hierarchical, network, relational, or object-oriented DBMS, or any other DBMS. Data store 130 can be a repository for one or more instantiations of ontology database 132 and time series database 134. Communication between the server and data store 130 can be either over electronic communication network 160, or a dedicated communication path.

Electronic communication network 160 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 160.

Connected to server 110 via electronic communication network 160 are one or more client computer(s) 140, 142, 144. The client computers can be any type of computing device suitable for use by an end user (e.g., a personal computer, a workstation, a thin client, a netbook, a notebook, tablet computer, etc.). The client computer can be coupled to a disk drive (internal and/or external).

Connected to electronic communication network 160 can be monitored device 150. In accordance with implementations, there can be any number of monitored devices connected to network 160. However, only one monitored device is depicted. Monitored device 150 can be a machine, a cellular phone, an engine, a vehicle, a turbine, an appliance, medical telemetry, an industrial process plant, etc. Located throughout monitored device 150 are one or more sensor devices 152, 154, . . . 15N. These sensor devices monitor the status of various conditions of the monitored device. The monitored data from the sensor devices can be communicated to time series database 134.

In accordance with implementations, a client computer can act as an access point to interface a user to the system. The user, either a human or automatic search generator, describes a data request in terms of one or more of the available models in model layer 118. The data request can include a time range.

The semantic parser consults one or more ontologies of semantic data store 132 to determine the set of values pertinent to the request. The semantic parser implements semantic web technology to parse the ontologies. For example, a metadata model in Resource Description Framework (RDF) can express data in terms of triples (i.e., subject, predicate, and object). Implementation of an RDF model permits triples to be encoded that are independent of the format of the DBMS in which the time series data is actually stored.

Handling the inquiry in this way allows a user to specify values as collections or in terms of constructs meaningful to a subject matter expert but not directly modeled in the underlying time series data store. By traversal of the models, the set of values to be queried is assembled.

Once this set is available, it is handed off to query generator 126 which is used as an adapter to query time series database 134. This query generator component is responsible for taking the time range and semantically-defined collection of values and assembling a query compatible with the particular time series store. This is handled via a collection of interchangeable connectors located in querying layer 114. The interchangeable connectors implement one or more APIs purposed to the translation and query tasks.

The operations at the time series data store are unaltered. The storage mechanism does not need to be altered or adapted to handle the new abstraction layer, provided it already provides mechanisms for accepting a structured query and outputting results which are returned to the calling access point. In the case that either of these functionalities are only partially implemented, or entirely unavailable, a wrapper application can be used as an intermediary handling incoming and outgoing communications between the semantic web components and the time series data store.

Upon return of a query result from the time series store, the access point performs any additional formatting required and returns the query results to the caller. This may include, but is not limited to, the return of the resulting data as RDF triples, serialized tabular records, and/or other machine or human readable format.

Embodying systems and methods provide for multiple, coherent views of relationships impacting time series data. These relationships remove the burden from the end-user, data consumer of creating and maintaining models used to query time series data. Also, global view applications can be developed and shared for different ontologies for different applications /analyses to use a pre-agreed means for contextualizing time series data.

The use of semantic web technologies makes the distributed operations of such a system extendable across networks. Separating the modeling of relations into the ontology, and then handling the query construction in a related module provides the ability to use a number of adapters which can be tailored to the time series store to be accessed. This division also allows the physical systems on which the semantics work is performed to be easily separated from the construction and later execution of the time series query.

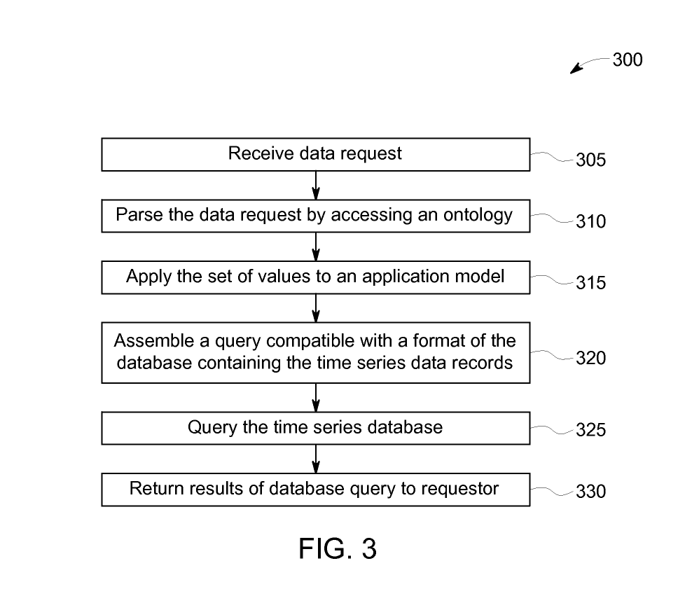

FIG. 3 depicts process 300 for querying time series data using a semantically-informed search in accordance with some embodiments. Process 300 can begin with receiving, step 305, a data request from a client computer. This data request can describe data in terms of one or more application models, and can include a time range for time series data. One or more ontologies can be parsed, step 310, using semantic web technology to determine a set of values pertinent to the received request.

The set of values from the parsed ontology is applied, step 315, to determine the appropriate items to query. A query is then assembled, step 320, where the query is compatible with a format implemented by the database containing the time series data records. The time series database is queried, step 325, to obtain values responsive to the query. The results of the query are optionally transformed before being returned, step 330, to the requestor.

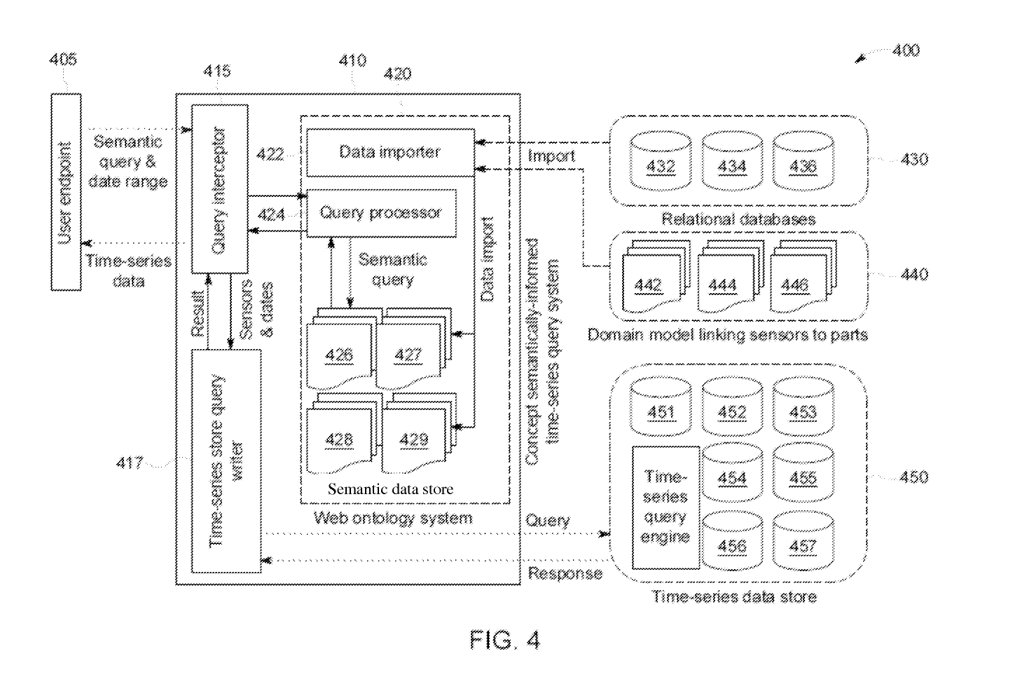

FIG. 4 depicts system 400 for implementing semantically-informed querying of time series data in accordance with embodiments. In accordance with embodiments, system 400 can include user endpoint 405 which itself can be a GUI interface, client computer, or other interface. System 400 also includes time-series query system 410 which includes semantic data store 420, query interceptor 415 and time-series store query writer 417. The semantic data store imports data via data importer 422 from relational database 430 and/or data files 440 which are used by the models describing the systems and situations related to the time series data.

Relational database 430 can contain one or more databases 432, 434, 436 that can contain static, non-time series data. This static non-time series data can include information that is of interest to the semantic model, for example if there were several monitored devices 150 that were race cars, then the static data could include driver names, car identity number, make/model of the car, racing team identity, etc. Data files 440 can include data files 442, 444, 446, which contain domain models linking sensors to part identifications in each of the race cars being monitored. These domain models can include meaningful descriptors of the parts and sensors that are within the semantics related to each race car make/model. For example, a torque sensor could be for engine shaft, transmission drive shaft, rear end differential, posi-traction differential, etc.

A query from user endpoint 450 is received by query interceptor 415. The query interceptor separates the received query into time-series specific portions and semantic portions. The semantic portion of the query is forwarded to semantic data store 420 for querying information from the relational databases and data files imported into the semantic store. The time-series specific portions of the query can include, for example, sensor identifications, and dates/times and/or date/time ranges, or other time-series specifics.

The time-series specific portion of the received query is forwarded to time-series store query writer 419 that prepares a time-series query for the time-series data store 450. Time-series data store 450 can include a time-series query engine and one or more databases 451-457 that contain time-series data from sensors and corresponding time data. A response to the time-series query from the time-series data store is returned to the query writer, which provides the response to the query interceptor.

The semantic portion of the received query is handled by query processor 424 which accesses data files 426-429. These data files contain data imported from relational data base 430 and data files 440. The response to the semantic portion of the received query is returned to the query interceptor. Query interceptor 415 merges the time-series response with the semantic response and provides a response to the received query to the user endpoint.

In accordance with some embodiments, the aforementioned databases can be in one data store, or multiple data stores or database management systems remotely located from one another and accessed via an electronic communication network. Each of the processors and/or engines discussed above can be implemented in one central control processor, or in multiple control processors that control the various portions of the system disclosed above.

By way of example, consider the following situation where a technician wishes to obtain data for analysis related to a power-generation turbine. The technician can be skilled in matters related to turbine operation but not in the various IT systems used to store turbine data. The technician would like information from the sensors in a gas turbine's hot gas path over a two week period. In conventional systems, the technician must either 1) be aware of the particulars of the information system, including names of all the sensors from which data is desired and query the time series storage system directly, or 2) request the data from a third party with such knowledge.

This introduces either an inappropriate expectation of indirectly-related domain knowledge on users or potential delays waiting on data. Using a system as disclosed herein, simplifies this process. By acting as an abstraction layer between the technician and the IT systems used to store the telemetry, the disclosed system insulates domain experts from needing particular insight into each storage system. Instead, a user can simply query for some variation on “sensor information for the hot gas path” over the two week period. This may be expressed symbolically or in controlled natural language but, ultimately, relies on the computable models to link the concept of a “hot gas path,” part of the turbine system as relevant to the technician, to the collection of storage entities relevant to the storage mechanism. These representations need not be directly connected in an intuitive manner. The designers of the telemetry repository are free to choose whichever representation best suits their needs. The system itself then accesses an ontology (computable model) that models the gas turbine.

From here, the system is able to determine the collection of sensors that are part of the “hot-gas path” and thereby considered in-scope. This information also yields the collection of symbolic identifiers and other vital information needed to query the telemetry for said sensors. The system then generates a query against the time series system. When the time series system query completes, the system gives the user the data desired. This saves the user from having to interact with multiple systems in order to obtain the desired data as well as needing specific information about lower-level naming and storage relevant to the query but not to their work.

In the above example, the models are used to translate the user's intent, finding the telemetry for the hot gas path over a given period, into a query against the system used to store such data. The abstraction layer provided by the disclosed system insulates the user from having to understand the particulars of the storage system. The ability to interact with the system in domain terms allows the maintenance of context for the user while interacting with the system and removes the need for intermediaries or per-system training.

The example can be expanded slightly to show the power and ease afforded by computable models. Assume the technician desired to obtain data on more than one turbine's hot gas path. Further, these turbines can be of different make, meaning that the collection of sensors comprising the hot gas paths differ between the several machines. In current systems, this requires the technician to obtain a full list of the sensors as named in the time series system then create a query that includes the full list. To obtain all responsive data could involve multiple interactions with the time series system, particularly in the case where the turbines have a disjoint set of sensors.

Using the disclosed system, this search is abstracted and achieved through the consultation of the models. The technician simply queries for the hot gas path telemetry of the collection of turbines. The system consults the models relevant to each of the turbines, determines the collection of sensors required internally, and queries the time series system. As the number and types of turbines of interest increases, the amount of work required of the requesting technician remains constant.

Using the models as part of an abstraction layer also provides the disclosed system with the flexibility to evolve to meet user's demands for shorthand representations of complex systems. Revisiting the above example, it is possible that it is discovered that a subsection of the hot gas path combined with another part of the turbine requires frequent, particular attention and analysis. In existing systems, these locations would be queried as individual sensors and collected together. The disclosed system's reliance on model-driven querying allows the models to be updated with new structures representing logical components which are frequently queried. In accordance with some implementations, the hot gas path and additional sensors could be grouped into a new logical structure that is reflected in updated models. The technician is now able to simply query against the new structures. This flexibility of the model-driven approach allows the evolution of the system to meet changing needs, provided they can be described by the ontologies.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for querying time series data using a semantically-informed search, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of querying time series data using a semantically-informed search, the method comprising:
receiving from a client computer a data request for time series data records stored in a time series database;
parsing the data request by accessing an ontology database to determine a set of values pertinent to the received request;
applying the determined set of values to a model representing a semantic relationship applicable to the time series data;
assembling a query compatible to a format implemented in the time series database;
querying the time series database with the assembled query;
merging the determined set of values with a response to the assembled query; and
returning the results of the merging step to the client computer.

2. The method of claim 1, wherein the received data request describes requested data in terms of one or more available models, the available models representing relationships applicable to the time series data.

3. The method of claim 1, the parsing step including implementing semantic technology to access the ontologies.

4. The method of claim 1, including expressing the time series data records in terms of triples encoded independently of the database format.

5. The method of claim 1, the assembling step including implementing an application programming interface to merge semantically-defined time ranges and the set of values.

6. The method of claim 1, including using a wrapper application to implement mechanisms for accepting the query and providing output results from the time series database.

7. A non-transitory computer-readable medium having stored thereon instructions which when executed by a processor cause the processor to perform a method of querying time series data using a semantically-informed search, the method comprising:
receiving from a client computer a data request for time series data records stored in a time series database;
parsing the data request by accessing an ontology database to determine a set of values pertinent to the received request;
applying the determined set of values to a model representing a semantic relationship applicable to the time series data;
assembling a query compatible to a format implemented in the time series database;
querying the time series database with the assembled query;
merging the determined set of values with a response to the assembled query; and
returning the results of the merging step to the client computer.

8. The medium of claim 6, including the received data request describing requested data in terms of one or more available models, the available models representing relationships applicable to the time series data.

9. The medium of claim 7, including instructions to cause the processor to perform the parsing step by implementing sematic technology to access the ontologies.

10. The medium of claim 7, including instructions to cause the processor to perform the step of expressing the time series data records in terms of triples encoded independently of the database format.

11. The medium of claim 7, including instructions to cause the processor to perform the assembling step by implementing an application programming interface to merge semantically-defined time ranges and the set of values.

12. The medium of claim 7, including instructions to cause the processor to perform the step of using a wrapper application to implement mechanisms for accepting the query and providing output results from the time series database.

13. A system for querying time series data using a semantically-informed search, the system comprising:
a server in communication with a client computer across an electronic communication network;
the system including an ontology database and a time series database, the time series database containing time series data records obtained from sensor devices monitoring a monitored device;
the server including a control processor, the control processor configured to execute operating instructions that cause the processor to:
receive from a client computer a data request for time series data records stored in a time series database;
parse the data request by accessing an ontology database to determine a set of values pertinent to the received request;
apply the determined set of values to a model representing a semantic relationship applicable to the time series data;
assemble a query compatible to a format implemented in the time series database;
query the time series database with the assembled query;
merge the determined set of values with a response to the assembled query; and
returning the results of the merge to the client computer

14. The system of claim 13, including the received data request describing requested data in terms of one or more available models, the available models representing relationships applicable to the time series data.

15. The system of claim 13, including instructions to cause the processor to perform the parsing step by implementing sematic technology to access the ontologies.

16. The system of claim 13, including instructions to cause the processor to perform the step of expressing the time series data records in terms of triples encoded independently of the database format.

17. The system of claim 13, including instructions to cause the processor to perform the assembling step by implementing an application programming interface to merge semantically-defined time ranges and the set of values.

18. The system of claim 13, including instructions to cause the processor to perform the step of using a wrapper application to implement mechanisms for accepting the query and providing output results from the time series database.
